(19) United States
(12) Patent Application Publication
(10) Pub. No.: US 2006/0085398 A1
(43) Pub. Date: Apr. 20, 2006

(54) System and method for augmenting presentation of patient-related medical information

(76) Inventor: Susan Ann Meyers, Stoughton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/967,932

(22) Filed: Oct. 19, 2004

(51) Int. Cl. G06F 17/30

(52) U.S. Cl. 707/3

(57) ABSTRACT

A system and method for augmenting presentation of patient-related medical information is provided. In one example, the medical information is displayed on a display according to predetermined formal display characteristics. A signal transmitter is operable by a caregiver to propagate a remote control signal when the caregiver desires to augment at least one of the predetermined formal display characteristics of the medical information. A receiver receives the remote control signal and control means are coupled to the receiver and control the display to augment the formal display characteristics of the medical information and thereby enhance the caregivers ability to view the medical information.

### FIELD OF THE INVENTION

The present application is related to a system and method for augmenting presentation of patient-related medical information.

### BACKGROUND OF THE INVENTION

In clinical settings, patient monitoring systems and patient treatment systems typically include means for communicating patient-related medical information to the caregiver. For example, a patient monitoring system will typically include a monitor which displays a plurality of physiological patient specific parameters and detailed information regarding the settings of the monitoring system. In addition, if any of the plurality of patient-related physiological parameters read outside of a normal or preset range, an alarm will be provided that notifies the caregiver of the situation. The alarm may be a visual indication on the screen and/or an audio indication.

In contemporary patient monitoring and treatment systems, there is typically a large quantity of patient-related medical information, including monitoring device and/or treatment device settings/parameters. Due to factors such as the large quantity of information being provided on a monitor screen, the small size of the screen, the viewing distance, and dim lighting in the clinical setting, patient-related medical information is typically not readable beyond a short distance, such as for example three feet from the monitoring/treatment device. In many instances, it is also very difficult for caregivers to move closer to the monitoring/treatment device because of the physical limitation of the area around a patient's bed, including equipment on the floor, inadequate space to walk, and various types of leads or tubing that extend to the patient and block a walking path to the display. In addition, caregivers often are involved in implementing necessary medical procedures and cannot approach the monitor at the same time.

### SUMMARY OF THE INVENTION

The present invention provides a system and method for augmenting presentation of patient-related medical information such that the information is readily available and/or viewable by a caregiver from a distance away from the monitoring/treatment device.

In one example, the system for augmenting presentation of patient-related medical information displays the medical information on a display according to predetermined formal display characteristics. A signal transmitter is operable by a caregiver to propagate a remote control signal when the caregiver desires to augment at least one of the predetermined formal display characteristics of the medical information. A receiver receives the remote control signal and control means are coupled to the receiver and control the display to augment the formal display characteristics of the medical information. Thus, the caregiver's ability to view the medical information is enhanced.

The formal display characteristics of the medical information can be augmented in many different ways, such as, for example, increasing the size of the medical information. It is also possible to alter the color of the displayed medical information.

The system and method is particularly useful to augment the communication of alarm information to the caregiver. For example, when the medical information is displayed on a monitor of a monitoring device, the control means can increase the size of the alarm information such that the caregiver can view and understand the alarm information from across a hospital room.

In another example, the method for conveying patient-related medical information that is displayed on a display according to predetermined formal display characteristics enhances the caregiver's ability to view the medical information. According to a first step, a signal transmitter is activated to propagate a remote control signal to change one of the formal display characteristics of the medical information. A receiver is provided which receives the remote control signal and the display is controlled based on the remote control signal received by the receiver to augment the formal display characteristics of the medical information.

### BRIEF DESCRIPTION OF THE DRAWINGS

Preferred embodiments are described herein below with reference to the attached drawing figures, wherein:

FIG. 1 shows a patient monitor associated with a patient treatment or monitoring device.

FIG. 2 shows a caregiver augmenting patient-related medical information shown on the patient monitor of FIG. 1.

FIG. 3 is a perspective view of one example of a signal transmitter.

FIG. 4 is a schematic showing one example of control means for augmenting presentation of patient-related medical information.

### DETAILED DESCRIPTION OF THE DRAWINGS

In the preferred embodiments of the present invention described in detail below, a system and method for augmenting presentation of patient-related medical information is provided. It should be understood that the drawings and specification are to be considered an exemplification of the principles of the invention, which is more particularly defined in the appended claims.

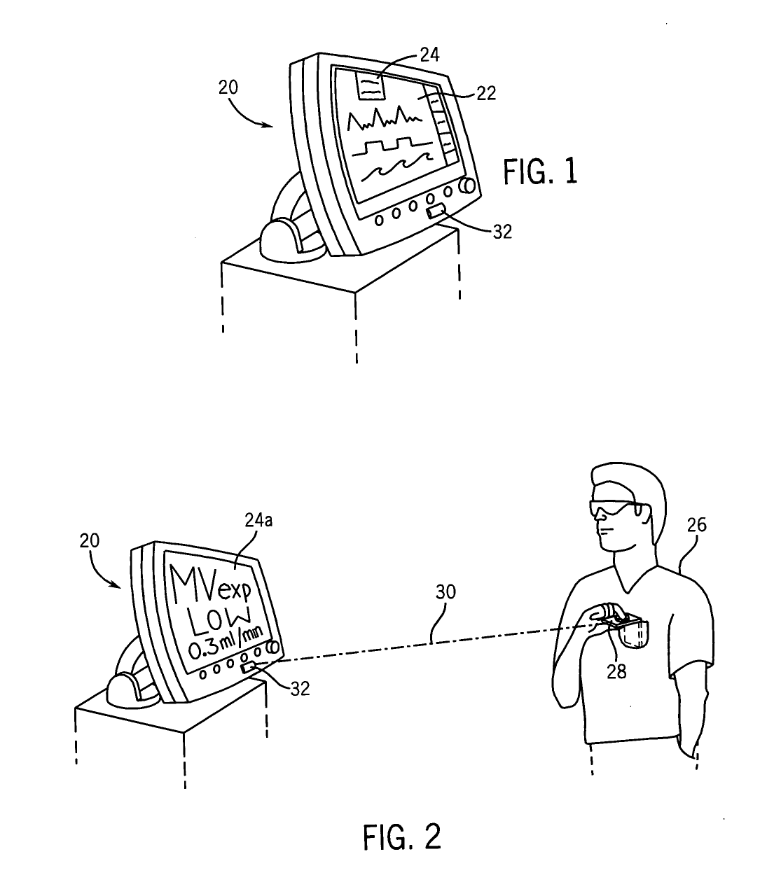

FIG. 1 depicts a patient monitor 20 for use with a patient monitoring device or patient treatment device (not shown). The patient monitor 20 has a display 22, which displays patient-related medical information. The patient-related medical information may include medical or physiological parameters related to the patient and/or monitoring device-specific or treatment device-specific parameters and values. The patient-related medical information may also include medical alarm notifications/information 24. In the embodiments shown, the alarm information 24 is presented in the upper portion of the display 22.

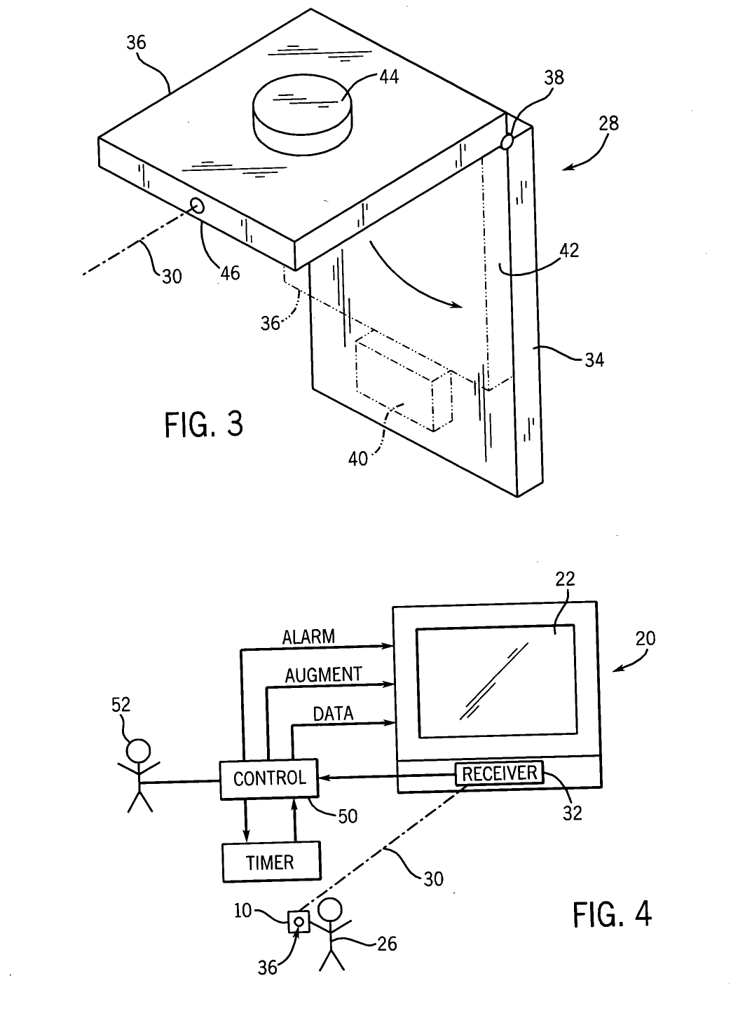

FIG. 3 depicts a transmitter unit 28, which is suitable for attaching to the clothing of a caregiver 26. Transmitter unit 28 has a base unit 34 and an active unit 36, which are connected by a moveable hinge 38. The base unit 34 encases the battery and electronics 40. The hinge 38 allows the active unit 36 to fold down into resting position 42 (shown in dotted lines) when the transmitter unit 28 is not in use. By depressing membrane button 44 or other actuator the electronics 40 initiates a remote control signal source 46 to transmit a remote control signal 30. In one embodiment the remote control signal source 46 may be an infrared emitting diode. In use, transmitter unit 28 may be fastened to the clothing of caregiver 26 by an appropriate clip on the back of base unit 34. In a preferred embodiment the transmitter unit comprises part of an identification badge for the caregiver 26.

Referring now to FIG. 2, when the caregiver 26 observes the alarm notification 24, or hears a corresponding audible alarm, the caregiver 26 activates the transmitter unit 28 by depressing membrane button 44. The transmitter unit 28 sends a remote control signal 30 in the direction of the monitor 20. In a preferred embodiment, the remote control signal 30 is an infrared signal. Receiver 32 receives the remote control signal 30 and according to the arrangement discussed further below, the alarm information display 24a is augmented to make it more visible when the caregiver is at a distance from the monitor 20. In the example shown in FIG. 2, the alarm information 24 is augmented by enlarging the information display 24a such that it is more easily viewed from a distance. In a preferred embodiment, the receiver 32 is an infrared receiver.

Referring now to FIG. 4, when the clinician 26 sees or hears an alarm in standard mode 24 but has difficulty seeing the alarm information 24 from his/her location, the caregiver 26 raises active unit 36, directs remote control signal source 46 towards monitor 20 and depresses button 44. The remote control signal 30 is transmitted and is thereafter received by receiver 32. This signal is sent to control circuitry 50, which controls the display 22 to increase the size of the alarm information 24a (as shown in FIG. 2) to enhance the readability of the alarm information 24a. Control circuitry 50 also has a timer. Once the timer counts a predetermined amount of time, typically between 1 and 3 seconds, control circuitry 50 controls the display 22 to return the alarm information 24a to standard operational mode, shown in FIG. 1.

It will also be recognized by those skilled in the art that the system and method of the present invention is applicable in a variety of settings and to a variety of medical apparatus. For example, a single transmitter may be used to augment the presentation of patient-related medical information on a plurality of displays, or monitors. Each of the monitors may include a dedicated receiver. Alternately, a single receiver may communicate with a plurality of displays. It will also be understood by those skilled in the art that a single controller may communicate with the plurality of displays to control the display of medical information thereon.

While the invention has been described with reference to preferred embodiments, those skilled in the art will appreciate that certain substitutions, alterations and omissions may be made without departing from the spirit thereof. For example, other types of electromagnetic energy than infrared may be used, if desired. And, other configurations for transmitter unit 28 may be employed. It will also be understood by those skilled in the art, that according to the system and method of the present invention, the caregiver may augment the medical information by changing its color. Accordingly, the foregoing description is meant to be exemplary only and should not be deemed limitative on the scope of the invention set forth with the following claims.

What is claimed is:

1. A system for augmenting presentation of patient-related medical information, which medical information is displayed on a display according to predetermined formal display characteristics, the system comprising:
a signal transmitter operable by a caregiver to propagate a remote control signal when the caregiver desires to augment at least one of the predetermined formal display characteristics of the medical information;
a receiver for receiving the remote control signal; and
a controller coupled to the receiver and controlling the display based on the remote control signal to augment the formal display characteristics of the medical information and thereby enhance the caregiver's ability to view the medical information.

2. The system of claim 1, wherein the at least one of the formal display characteristics is the size of the medical information and the controller controls the display to increase the size of the medical information.

3. The system of claim 1, wherein the medical information is alarm information.

4. The system of claim 1, wherein the remote control signal is receivable by a desired receiver coupled to and controlling the display of one or more monitors.

5. The system of claim 1, wherein the at least one of the formal display characteristics is the color of the medical information and the control means controls the display to change the color of the medical information.

6. The system of claim 1, wherein the augmented medical information is displayed for a predetermined amount of time before returning to the predetermined formal display characteristic.

7. The system of claim 1, wherein the signal transmitter propagates an electromagnetic remote control signal.

8. The system of claim 7, wherein the signal transmitter propagates a directional electromagnetic signal.

9. The system of claim 8, wherein the signal transmitter propagates an infrared (IR) electromagnetic signal and the receiver is an infrared (IR) receiver.

10. The system of claim 9, wherein the signal transmitter has an IR emitting diode.

11. The system of claim 1, wherein the signal transmitter comprises an activator for activating the signal transmitter.

12. The system of claim 1, wherein the signal transmitter has means for attaching the signal transmitter to the clothing or equipment of a caregiver.

13. The system of claim 1, wherein the signal transmitter comprises part of an identification badge for a caregiver.

14. The system of claim 1, wherein the display is a monitor.

15. A method for conveying patient-related medical information, which medical information is displayed on a display according to predetermined formal display characteristics, the method comprising the steps of:
activating a signal transmitter to propagate a remote control signal to change one of the formal display characteristics of the medical information;
providing a receiver which receives the remote control signal; and
controlling the display based on the remote control signal received by the receiver to augment the formal display characteristics of the medical information and thereby enhance a caregiver's ability to view the medical information.

16. The method of claim 15, further comprising the step of displaying the augmented display of medical information for a predetermined time period before returning to the predetermined formal display characteristics.

17. The method of claim 15, wherein the remote control signal is received by at least one receiver to augment the formal display characteristics of medical information on a plurality of displays.

18. The method of claim 15, wherein the size of the display of medical information is increased.

19. The method of claim 15, wherein the medical information comprises alarm information.

20. The method of claim 15, wherein the signal transmitter comprises an activator for activating the signal transmitter.

21. A system for modifying a presentation of patient-related medical information, the system comprising:
communication means capable of communicating the medical information in a predetermined form and in an augmented form that is more easily received by the clinician than the predetermined form;
a signal transmitter operable by a caregiver to propagate a remote control signal when the caregiver desires to augment the presentation of the medical information;
a receiver for receiving the remote control signal; and
control means coupled to the receiver and controlling the communication means to selectively communicate the medical information in the predetermined form and in the augmented form.

22. The system of claim 21, wherein the communication means comprises a display and the medical information is provided on the display.

23. The system of claim 22, wherein the augmented form of medical information is larger than the predetermined form of medical information.

24. The system of claim 22, wherein the augmented form of medical information is a different color than the predetermined form.

25. The system of claim 21, wherein the medical information comprises alarm information.

26. The system of claim 21, wherein the augmented form of medical information is displayed for a predetermined amount of time before returning to the predetermined form.

27. The system of claim 21, wherein the signal transmitter propagates an electromagnetic remote control signal.

28. The system of claim 21, wherein the communication means is a monitor.

29. The system of claim 21, wherein the signal transmitter comprises an activator for activating the signal transmitter.

30. The system of claim 21, wherein the signal transmitter comprises part of an identification badge for a caregiver.
